(19) United States
(12) Patent Application Publication
(10) Pub. No.: US 2001/0040412 A1
(43) Pub. Date: Nov. 15, 2001

(54) Radial gap, rotary yoke type brushless vibration motor

(76) Inventor: Tadao Yamaguchi, Gunma-ken (JP)

Correspondence Address: LEYDIG VOIT & MAYER, LTD, 700 THIRTEENTH ST. NW, SUITE 300, WASHINGTON, DC, 20005-3960, US

(21) Appl. No.: 09/781,320

(22) Filed: Feb. 13, 2001

(30) Foreign Application Priority Data
Feb. 14, 2000 (JP) 2000-39718
Jan. 25, 2001 (JP) 2001-17131

(51) Int. Cl. H02K 7/065; H02K 21/12

(52) U.S. Cl. 310/81; 310/156.01

(57) ABSTRACT

A radial gap, rotary yoke type brushless vibration motor which is driven by a sensor-less method includes a support body having a flat installation portion, a cylindrical coreless stator coil, one end of which is supported at the support body and the other end of which is open, a plurality of terminal portions arranged at the support body for connecting to the end of the cylindrical coreless stator coil at the support body, a shaft supported at the center of the support body, a cylindrical rotary yoke, functioning as an eccentric rotor supported by the shaft, accommodated inside the cylindrical coreless stator coil and separated from the cylindrical coreless stator coil via a radial gap, a rotor case, one end of which is fixed at the cylindrical rotary yoke, the rotor case made with a cut-out portion so as to be eccentric, and a magnet arranged inside the rotor case so as to face the outer circumference of the cylindrical coreless stator coil, the magnet separated from the cylindrical coreless stator coil via a radial gap.

### BACKGROUND OF THE INVENTION

1. Field of the Invention

The present invention relates to a radial gap, rotary yoke type brushless vibration motor having an improved structure suitable for a silent call means of a portable communications apparatus such as a mobile phone.

2. Description of the Related Art

In a conventional silent call means used for a pager or a mobile phone, as shown in FIG. 7, an eccentric weight W formed of tungsten alloy is arranged at one end of an output shaft S of a cylindrical coreless DC motor M. During rotation, the eccentric weight W generates vibrations due to an unbalanced centrifugal force.

However, in the case of installing the eccentric weight W at the conventional output shaft S, there is a limit in design because a space for rotation of the eccentric weight W must be considered. Also, since a tungsten alloy which is expensive is used as a material for the eccentric weight, a cost for production increases. Further, since contact type electricity feeding parts such as a brush and a commutator are required for a cylindrical coreless DC motor, a long term durability cannot be secured.

Given the above situation, the present applicant suggest a brushless vibration motor which uses as a eccentric rotor a cylindrical magnet, part of which is cut out in an axial direction, which is disclosed in FIG. 1 of Japanese Patent Publication No. 6-284662. In this structure, while greater vibrations can be obtained since the magnet is eccentric, the properties of the motor are sacrificed instead.

### SUMMARY OF THE INVENTION

To solve the above problems, it is an object of the present invention to provide a radial gap, rotary yoke type brushless vibration motor in which an output shaft and an eccentric weight attached thereto are removed so that cost can be reduced, unnecessary members such as a bearing holder can be omitted by making a shaft fixed type leading to a simplified and compact structure, a space for rotation of an eccentric weight does not need to be considered so that the motor can be easily mounted on a printed circuit board, and the properties of the motor are not deteriorated.

Accordingly, to achieve the above object, there is provided a radial gap, rotary yoke type brushless vibration motor which is driven by a sensor-less method includes a support body having a flat installation portion, a cylindrical coreless stator coil, one end of which is supported at the support body and the other end of which is open, a plurality of terminal portions arranged at the support body for connecting to the end of the cylindrical coreless stator coil at the support body, a shaft supported at the center of the support body, a cylindrical rotary yoke, functioning as an eccentric rotor supported by the shaft, accommodated inside the cylindrical coreless stator coil and separated from the cylindrical coreless stator coil via a radial gap, a rotor case, one end of which is fixed at the cylindrical rotary yoke, the rotor case made with a cut-out portion so as to be eccentric, and a magnet arranged inside the rotor case so as to face the outer circumference of the cylindrical coreless stator coil, the magnet separated from the cylindrical coreless stator coil via a radial gap.

It is preferred in the present invention that terminal portions fixed to a printed circuit board by reflow soldering is installed at the support body.

Also, it is preferred in the present invention that the eccentric rotor is installed such that the shaft of the eccentric rotor can be installed in a horizontal direction and a rotation outer circumference recess portion for making a low profile is installed at the support body.

Also, it is preferred in the present invention that the eccentric rotor installed such that the shaft of the eccentric rotor can be installed in a vertical direction, the terminal portion is installed at the side of the support body, and the rotary yoke includes bearings having a magnetic body.

Also, it is preferred in the present invention that a cover for covering the rotor is arranged.

### BRIEF DESCRIPTION OF THE DRAWINGS

The above object and advantages of the present invention will become more apparent by describing in detail preferred embodiments thereof with reference to the attached drawings in which:

FIG. 1 is a sectional view in the axial direction of a radial gap, rotary yoke type brushless vibration motor according to a preferred embodiment of the present invention;

FIG. 2 is a sectional view in the radial direction of the motor of FIG. 1;

FIG. 3 is a right side view of the motor of FIG. 1;

FIG. 4 is a perspective view of the motor of FIG. 1;

FIG. 5 is a sectional view in the axial direction of a radial gap, rotary yoke type brushless vibration motor according to another preferred embodiment of the present invention;

FIGS. 6A and 8B are views for explaining a principle of driving of the radial gap, rotary yoke type brushless vibration motor according to the present invention;

FIG. 7 is a perspective view of a conventional DC motor having an eccentric weight.

### DETAILED DESCRIPTION OF THE INVENTION

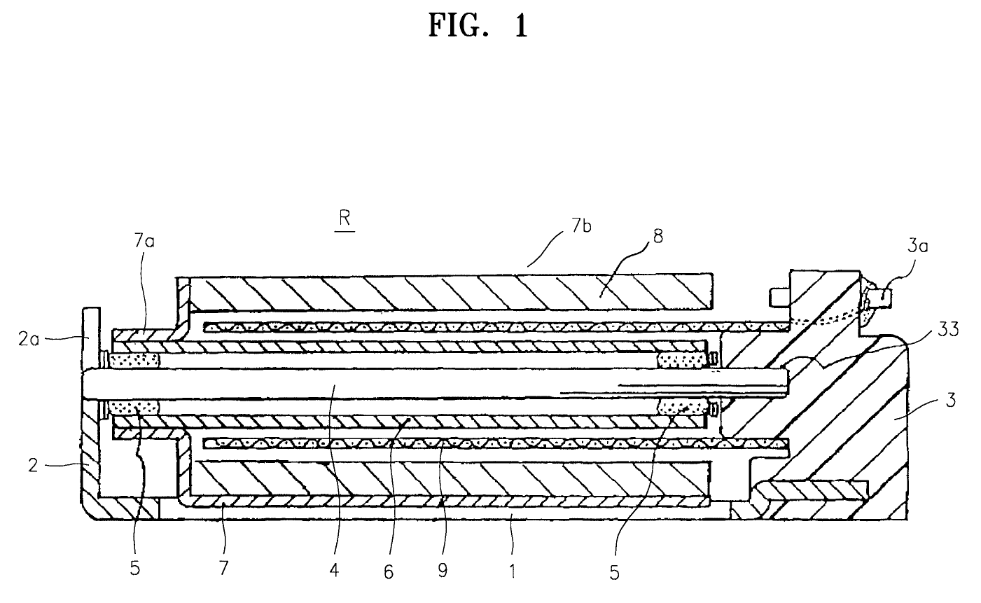

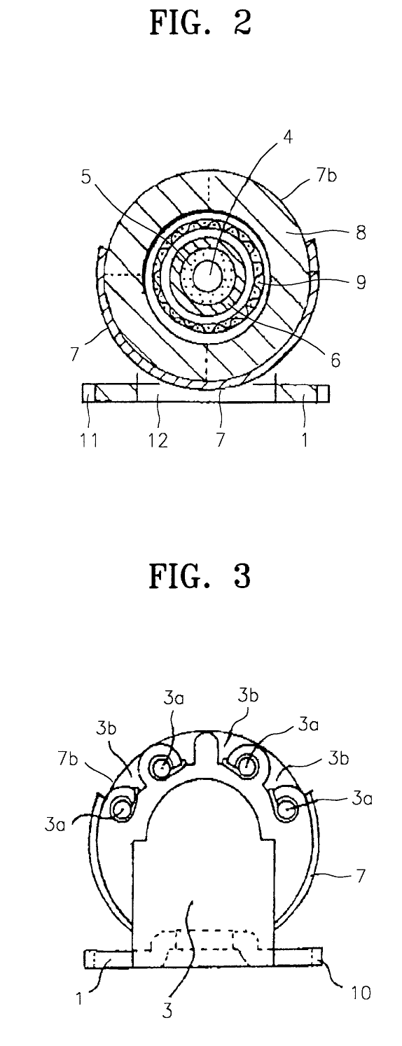

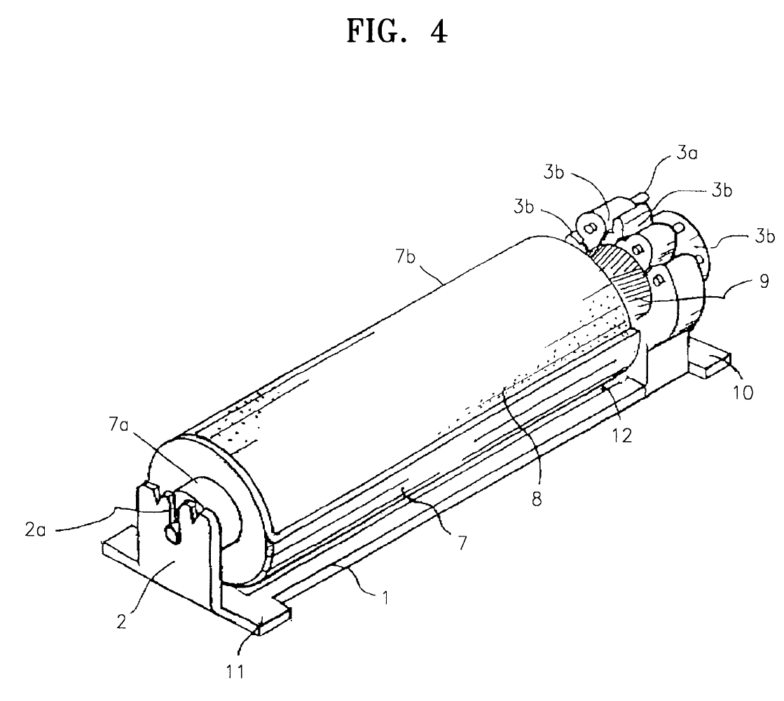

Referring to FIG. 1, a raised portion 2 is formed by bending one end of a support body 1 formed of a tin plate. A stator holder 3 formed of synthetic resin is outsert-formed at or is pressed onto the other end of the support body 1. Since the bottom of the support body 1 and the stator holder 3 form a flat surface, the support body 1 can be placed on a printed circuit board. Reference numeral 4 denotes a shaft which is formed in the raised portion 2 after an eccentric rotor or a stator coil is installed at the shaft 4. One end of the shaft 4 is fixedly inserted in an insertion hole 33 formed in the stator holder 3 and the other end of which is fixedly inserted in a U-shaped portion 2a, to be described in detail in FIG. 4, The shaft 4 is fixedly installed at the U-shaped portion 2a by using wedges. A thin and elongated, pipe-shaped rotary yoke 6 is rotatably installed at the shaft 4 via a pair of bearings 5. A neck portion 7a which is a thinner part of a cylindrical rotor case 7 is fixedly installed at the outer side of one end of the rotary yoke 6. It is a characteristic feature of the present invention that a cut-out portion 7b is formed in an axial direction of the motor making an open angle of 150° with respect to the shaft 4 at the cylindrical rotor case 7, thus constituting an eccentric rotor R. Reference numeral 8 denotes a cylindrical field magnet, the outer circumference of which is fixed to the eccentric rotor case 7, and constitutes a magnetic circuit together with the rotary yoke 6.

A cylindrical coreless coil 9 which is a stator for driving the eccentric rotor R is formed by winding a self-welding wire. A base portion of the coreless coil 9 is fixedly inserted in part of the support body 1 such that the coreless coil 9 can be accommodated between the rotary yoke 6 and the field magnet 8 via a predetermined radial gap. Each of end portions of the coreless coil 9 which becomes a stator is connected to four terminal pins 3a arranged at the stator holder 3 through a groove 3b, as shown in FIG. 3 in a unipolar sensorless method.

Referring to FIG. 4, reference numerals 10 and 11 denote an installation portion incorporating the support body 1 for soldering the motor to be fixed to a printed circuit board (not shown). Also, reference numeral 12 denotes a recess portion of the rotor R installed at the support body 1, enabling a low profile. As the rotor R extends in a radial direction, the amount of eccentricity and vibrations increases.

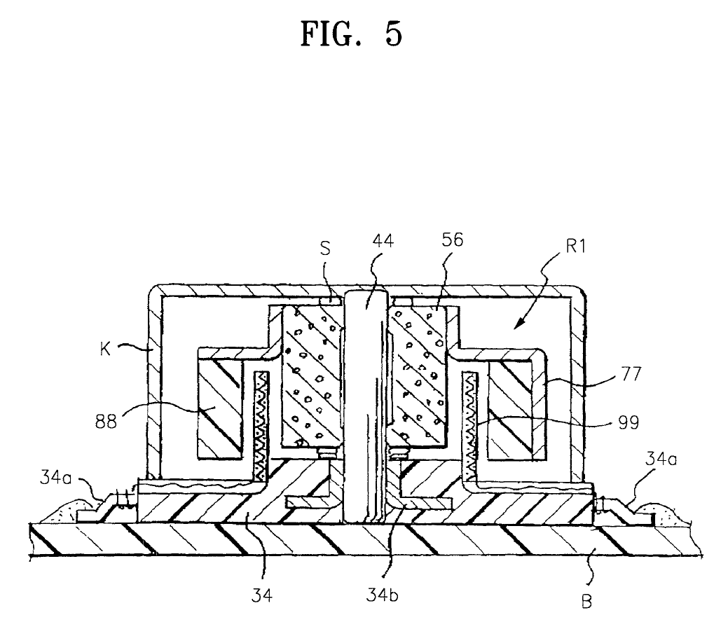

FIG. 5 shows a flat radial gap, rotary yoke which can be mounted vertically on an apparatus. That is, the bottom surface of a support body 34 is flat so that it can be placed on a printed circuit board B. A plurality of terminals 34a are integrally formed at the side surface of the support body 34. A shaft 44 is fixedly supported by a reinforced portion 34b formed of the same material as the terminals 34a which is installed at the center of the support body 34 and insulated from the terminals 34a. Also, a part of outside the reinforcement portion 34b the support body 34 supports one end of the thin cylindrical coreless stator coil 99.

An eccentric rotor R1 is rotatably installed at the shaft 44 via an oilless bearing 56. The oilless bearing 56 is formed of a sintered body including iron and installed to face the inner circumferential surface of the stator coil 99 via a radial gap provided in an radial direction. Simultaneously, a rotor case 77 having a cylindrical field magnet 88 is fixed to one end of the oilless bearing 56 such that it can face the outer circumferential surface of the stator coil 99 via a radial gap in the radial direction. The rotor case 77 is made eccentric by removing part thereof.

The eccentric rotor R1 is covered by a stainless cover K and insulated from the stainless cover K with a thrust washer S. Then, the motor is mounted on the printed circuit board B by reflow soldering. Thus, since the oilless bearing 56 is formed of a sintered body including iron, it forms a magnetic circuit as a rotary yoke so that a hysteresis loss is reduced.

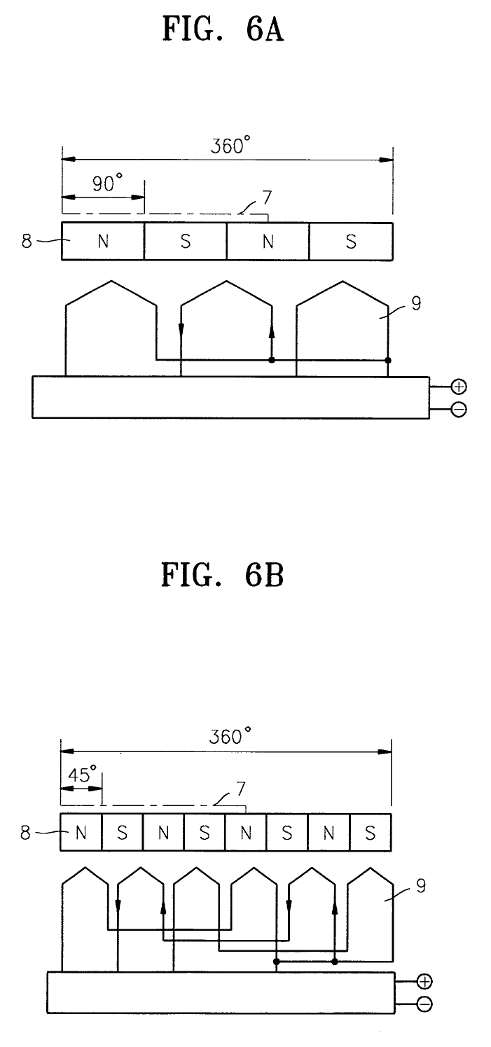

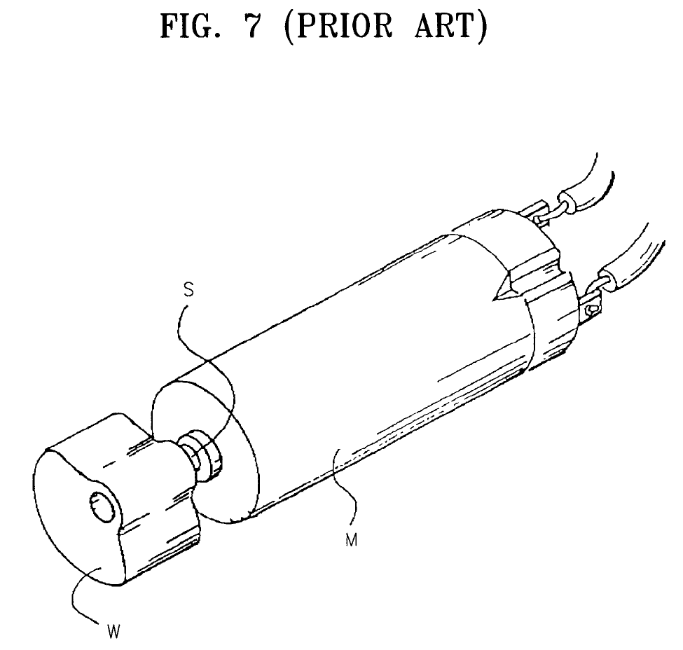

Referring to FIGS. 6A and 6B, the operations of 3-electronic coil, 4-pole magnet type and 6-armature coil, 8-pole magnet type for driving the present motor in a unipolar type sensor-less method, are shown. Here, since a well-known counter-electromotive voltage detecting method is used for the sensor-less method, a detailed description thereof will be omitted. Since at least one coil of each armature necessarily contributes to the generation of torque, it is certain that the armature can start rotating, that is, that there will be no dead spots in which the motor cannot start.

Also, although a unipolar, sensor-less method is described in the above, a well-know bipolar, sensor-less method can be used.

It is noted that the present invention is not limited to the preferred embodiment described above, and it is apparent that variations and modifications by those skilled in the art can be effected within the spirit and scope of the present invention defined in the appended claims.

As described above, according to the present invention, a fixed shaft is used while an output shaft and an eccentric shaft are removed so that the structure of the vibration motor is simplified and the cost thereof is reduced. Also, the vibration motor can be easily mounted on a printed circuit board by reflow soldering without considering a space for rotation of the eccentric weight in design. Since part of the magnet does not need to be removed to make the magnet eccentric, a brushless vibration motor can be obtained without sacrificing the features of the motor.

What is claimed is:

1. A radial gap, rotary yoke type brushless vibration motor which is driven by a sensor-less method, the motor comprising:
a support body having a flat installation portion;
a cylindrical coreless stator coil, one end of which is supported at the support body and the other end of which is open;
a plurality of terminal portions arranged at the support body for connecting to the end of the cylindrical coreless stator coil at the support body;
a shaft supported at the center of the support body;
an eccentric rotor supported by the shaft, having a cylindrical rotary yoke, accommodated inside the cylindrical coreless stator coil and separated from the cylindrical coreless stator coil via a radial gap, a rotor case, one end of which is fixed at the cylindrical rotary yoke, the rotor case made with a cut-out portion so as to be eccentric, and a magnet arranged inside the rotor case so as to face the outer circumference of the cylindrical coreless stator coil, the magnet separated from the cylindrical coreless stator coil via a radial gap.

2. The motor as claimed in claim 1, wherein terminal portions fixed to a printed circuit board by soldering is installed at the support body.

3. The motor as claimed in claim 1, wherein the eccentric rotor is installed such that the shaft of the eccentric rotor can be installed in a horizontal direction and a rotation outer circumference recess portion for making a low profile is installed at the support body.

4. The motor as claimed in claim 1, wherein the eccentric rotor is installed such that the shaft of the eccentric rotor can be installed in a vertical direction, the terminal portions are installed at the side of the support body, and the rotary yoke includes bearings having a magnetic body.

5. The motor as claimed in claim 4, wherein a cover for covering the rotor is arranged.
